(19) United States
(12) Patent Application Publication
(10) Pub. No.: US 2025/0283999 A1
(43) Pub. Date: Sep. 11, 2025

(54) Method for Operating a Measuring Device

(71) Applicant: Robert Bosch GmbH, Stuttgart (DE)

(72) Inventors: Lukas Fiederer, Balingen (DE); Andreas Frischen, Leonberg (DE); Andreas Koelsch, Peiting (DE); Anke Giliard, Stuttgart (DE); Benjamin Moster, Niefern-Oeschelbronn (DE); Heiko Sgarz, Leonberg (DE); Jan Linus Steuler, Woelfersheim (DE); Judith Borowski, Ho Chi Minh City (VN); Uwe Troeltzsch, Roesrath (DE)

(21) Appl. No.: 19/072,486

(22) Filed: Mar. 6, 2025

(30) Foreign Application Priority Data
Mar. 11, 2024 (DE) 10 2024 202 229.2

(51) Int. Cl. G01S 13/88; G06N 20/00

(52) U.S. Cl. CPC G01S 13/888; G06N 20/00

(57) ABSTRACT

A computer-implemented method for operating a measuring device, in particular a wall diagnostic device, includes (i) receiving radar data of a radar sensor unit of the measuring device, (ii) performing wall diagnostics by performing an analysis of the radar data and providing diagnostic results via a diagnostic module of the measuring device, and (iii) determining feedback information.

This application claims priority under 35 U.S.C. § 119 to application no. DE 10 2024 202 229.2, filed on Mar. 11, 2024 in Germany, the disclosure of which is incorporated herein by reference in its entirety.

The present disclosure relates to a method for operating a measuring device, in particular a wall diagnostic device.

### BACKGROUND

Diagnostic devices for performing wall diagnostics and detecting objects formed in the walls are known from prior art.

An object of the present disclosure to provide an improved method for operating a measuring device, in particular a wall diagnostic device. It is further an object to provide an improved method for training an artificial intelligence of a measuring device.

The object is achieved by the method as set forth below. Advantageous embodiments are subject-matter also set forth below.

### SUMMARY

According to one aspect, a computer-implemented method of operating a measuring device, in particular a wall diagnostic device is provided, comprising:
receiving radar data from a radar sensor unit of the measuring device, wherein the radar data depicts a wall on which diagnostics are to be performed;
performing wall diagnostics by performing an analysis of the radar data and providing diagnostic results via a diagnostic module of the measuring device, wherein the wall diagnostics comprise:
performing a wall type classification and determining a wall type of the wall by way of the diagnostic module, wherein the diagnostic results comprise at least the wall type of the wall; and/or
performing an object recognition of an object disposed in the wall using the diagnostic module, wherein the object recognition comprises an object detection and an object classification, and determining an object position in the wall and an object type of the object, and wherein the diagnostic results comprise at least the object position and/or the object type;
determining feedback information, wherein the feedback information describes whether the diagnostic results match a current state of the wall.

The technical advantage can thereby be achieved that an improved method for operating a measuring device, in particular a wall diagnostic device, can be provided. For this purpose, radar data of a radar sensor unit of the measuring device for a wall to be diagnosed is first received. Based on the radar data, a wall diagnostics is subsequently performed of the wall to be diagnosed by a diagnostic module of the measuring device.

The wall diagnostics includes performing a wall type classification and determining a wall type of the wall and/or performing object recognition for an object disposed in the wall using the diagnostic module. The object recognition includes object detection with the determination of an object position and an object classification with the determination of an object type.

Feedback information is also determined. The feedback information here describes determining whether the diagnostic results generated during the wall diagnostics match a current state of the wall.

By using the correspondingly configured diagnostic module, it can be achieved that no additional sensor information is needed in addition to the radar data for the wall diagnostics, in particular for determining the wall type and/or determining the object type. The wall type and/or the object type may be determined solely based on the radar data of the radar sensor unit. The measuring device therefore need not be equipped with additional sensors.

By automatically determining the wall type as part of the wall diagnostics, it can be avoided that the user of the measuring device must manually enter the present wall type of the wall to be examined. Further, because the diagnostic module automatically determines the wall type, the correspondingly determined wall type can be used in the further wall diagnostics, for example as a background correction for object recognition. This may further improve the quality of the wall diagnostics.

By determining the feedback information, the quality of the wall diagnostics performed may be checked directly. The feedback information may in particular be used to improve the wall diagnostics, for example, by updating the diagnostic module.

According to one embodiment, the method furthermore comprises: providing the feedback information to an external server unit to take the feedback information into account in an update of the diagnostic module.

By doing so, the technical advantage may be achieved that, by providing the feedback information to an external server unit, the feedback information provided accordingly may be used to improve the performance of the diagnostic module. For example, the feedback information may be from a plurality of measuring devices which are in operation. The performance of the diagnostic modules installed in the measuring devices can be checked by the server unit using the comprehensive feedback information gathered in this way. This allows for a targeted update of the software of the diagnostic module, wherein the goal of the respective update is to improve the aspects of the diagnostic module that have insufficient performance according to the feedback information.

According to one embodiment, the corresponding radar data of the external server unit is provided in addition to the feedback information.

This may achieve the technical advantage that, by providing the radar data of the measuring devices in addition to the feedback information of the external server unit, a comprehensive description of the situation in which the measuring device created the diagnostic results and that resulted in the feedback information can be provided. The update or improvement of the diagnostic module can thereby be further improved.

According to one embodiment, performing the wall diagnostics further comprises: performing an object depth determination and determining an object depth of the object in the wall using the diagnostic module, wherein the object depth is defined as a distance of the object to a surface of the wall; and/or performing an object extent determination and determining an object extent of the object along a predefined direction by the diagnostic module, wherein the diagnostic results further comprise at least the object depth and/or the object extent of the object.

This may achieve the technical advantage that a comprehensive wall diagnostics can be performed. To this end, the wall diagnostics include determining an object depth and/or determining an object extent in addition to determining the wall type and/or the object position and/or the object type. By considering the object depth and/or the object extent, a detailed description of the objects detected by the measuring device can be provided.

According to one embodiment, a plurality of possible object positions and/or a plurality of possible object types of the object are determined in the object recognition as stand-alone diagnostic results, and/or wherein a plurality of possible wall types of the wall are determined as stand-alone diagnostic results in the wall type classification, and/or wherein a plurality of possible object depths are determined as stand-alone diagnostic results in the object depth determination and/or wherein a plurality of possible object depths of the object are determined as stand-alone diagnostic results in the object extent determination, wherein each of the plurality of diagnostic results are displayed in a display unit of the measuring device.

This can achieve the technical advantage of enabling a detailed wall diagnostics. In that multiple object positions and/or multiple object types and/or multiple object depths and/or multiple object extents and/or multiple wall types are determined in the wall diagnostics and displayed in the display unit of the measuring device, a comprehensive image of the wall to be diagnosed can be provided to the user.

According to one embodiment, the method furthermore comprises:
providing a first selection function and/or a second selection function, wherein, when the first selection function is carried out a user of the measuring device, at least one of the displayed wall types and/or one of the displayed object positions and/or object types and/or object depths and/or object extents is selectable, and/or wherein, when the second selection is carried out function by the user of the measuring device, the automatic determination of the wall type during the wall diagnostics and/or the display of the automatically determined wall type in the display unit can be deactivated and a wall type is manually selectable by the user.

This can achieve the technical advantage that the first selection function allows the user to select the appropriate wall type for the wall to be examined from the plurality of wall types displayed. If the wall type of the wall to be examined is known, the user can select the best suitable possible wall type provided by the measuring device. The selected wall type can be used for further wall diagnostics, while the non-selected wall types are not taken into account. This may further improve the quality of the wall diagnostics.

By way of the second selection function, the user can deactivate the automatic determination of the wall type and select the appropriate wall type manually. This may be particularly advantageous for diagnostic situations in which the user knows the wall type of the present wall and the possible wall types provided by the measuring device do not completely depict the wall type actually present. Again, this may increase the quality of the wall diagnostics.

According to one embodiment, the method furthermore comprises: providing a feedback function, wherein, when the user caries out the feedback function, a match between the displayed wall type and/or the displayed object position and/or the displayed object type and/or the displayed object depth and/or the displayed object extent and the actual wall type and/or the actual object position and/or the actual object type and/or the actual object depth and/or the actual object extent can be determined.

This may achieve the technical advantage that, through provision of the feedback function, clear feedback information regarding whether the displayed wall types match the actual wall type and/or the displayed object position and/or the displayed object type and/or the displayed object depth and/or the displayed object extent match the actual object positions, the actual object types, the actual object depths and/or the actual object extents. Thus, by actuating the feedback function, it is possible to actively provide feedback information regarding the quality of the wall diagnostics performed. This will allow for the determination of detailed and relevant feedback information. For example, the feedback feature comprises an input feature that allows the user to manually enter the feedback.

According to one embodiment, determining the feedback information comprises: receiving selection commands of the first and/or second selection functions and/or feedback commands of the feedback function and determining the feedback information based on the selection commands and/or feedback commands, wherein corresponding selections are made in the selection commands according to the first and/or second selection functions, and wherein the feedback commands contain corresponding feedback information provided by the user.

This may achieve the technical advantage that the feedback information may be determined based on the received selection commands of the first and second selection functions and/or the feedback commands of the feedback function. This may make it possible to provide detailed feedback information on the quality of the wall diagnostics performed.

According to one embodiment, determining the feedback information comprises:
determining, using the diagnostic module, whether there are deviations from the diagnostic results determined in the wall diagnostics when repeated diagnostics are carried out for a same position of the measuring device relative to the wall; and
displaying the deviations in the display unit; and
receiving feedback commands from the user regarding the deviations, wherein the displayed deviations are confirmed or refuted in the feedback commands.

This can achieve the technical advantage of enabling improved wall diagnostics. As a result, using the diagnostic module, deviations between the diagnostic results of several wall diagnoses performed by the measuring device for identical positions of the measuring device relative to the wall are determined. The deviations may be displayed in the display unit. The user may provide feedback information regarding the deviations in which the deviations are confirmed or refuted via the feedback function. The consistency of the wall diagnostics can thereby be checked and documented. The corresponding feedback information may further be considered for improving the diagnostic module.

According to one embodiment, the measuring device further comprises at least one of an induction sensor and/or an eddy current sensor and/or a capacitance sensor and/or an AC current sensor and/or an NMR sensor and/or an ultrasonic sensor for providing additional sensor data, wherein the diagnostic module is configured to perform the wall diagnostics by taking into account the additional sensor data.

The technical advantage can thereby be achieved that, through further sensor data, additional sensors, each of which is configured to detect different physical variables, can provide additional information in addition to the radar data of the radar sensor unit, for incorporation into the wall diagnostics. This additional information, which is preferably complementary to the information of the radar data of the radar sensor unit, allows further precise specification of the wall diagnostics and the object recognition, respectively.

According to one embodiment, the diagnostic module comprises at least one correspondingly trained artificial intelligence configured to perform an object recognition and/or a wall classification and/or an object depth determination and/or an object extent determination based on the radar data and/or the additional sensor data.

The technical advantage can thereby be achieved that, because the diagnostic module is configured as a correspondingly trained artificial intelligence structure, which is trained based on the radar data, or, if applicable, taking into account the information of the additional sensors, to perform an object recognition and/or a wall classification and/or an object depth determination and/or an object extension determination, a reliable and powerful diagnostic module can be provided. By using the artificial intelligence technology, precise wall diagnostics can be provided.

According to one embodiment, the object classes of the object type of the object comprise: metallic/non-metallic object, low voltage cable, cable with single phase AC signal, cable with multiphase AC signal, wood beam, metal beam, plastic pipe, water filled plastic pipe, for example fresh water pipe, non-water filled plastic pipe, for example waste water pipe, and/or wherein the wall type classes of the wall comprise: Concrete wall, plasterboard/drywall wall, brick wall and/or bricks of the wall and/or wall with surface heating, such as underfloor heating or wall heating.

The technical advantage may thereby be achieved that objects and walls of different types may be detected and classified. For example, metallic objects may include metallic pipes, metallic rods, metallic beams, metallic cables, and any other metallic objects commonly found in wall structures.

According to one aspect, a method for training an artificial intelligence structure of a wall diagnostic measuring device is provided, comprising:
providing a training dataset for training an artificial intelligence, wherein the training dataset comprises a wall and radar data depicting an object formed in the wall as well as the feedback information provided according to the method for operating a measuring device;
training the artificial intelligence based on the training dataset and taking into account the feedback information to perform object recognition of an object formed in a wall, wherein the object recognition comprises at least one object detection and one object classification.

In this way, the technical advantage can be achieved that improved training of the artificial intelligence of the wall diagnostic device, in particular post-training, is enabled, in which feedback is taken into account by the user of the wall diagnostic devices.

Provided according to one aspect is a computing unit configured to perform the method of operating a measuring device according to one of the preceding embodiments and/or the method of training an artificial intelligence.

According to one aspect, a computer program product is provided, comprising instructions that, when the program is executed by a data processing unit, cause the data processing unit to perform the method for operating a measuring device according to one embodiment and/or the method for training an artificial intelligence.

### BRIEF DESCRIPTION OF THE DRAWINGS

Embodiments of the disclosure are described with reference to the following figures. The figures show:

FIG. 1 a schematic representation of a measuring device according to one embodiment;

FIG. 2 a further schematic representation of the measuring device according to a further embodiment;

FIG. 3 a further schematic representation of the measuring device according to a further embodiment;

FIG. 4 a schematic representation of a measurement of the measuring device according to one embodiment,

FIG. 5 a further schematic representation of the measuring device according to a further embodiment;

FIG. 6 a schematic representation of a system for operating a measuring device according to one embodiment,

FIG. 7 a flowchart of a method for operating a measuring device according to one embodiment,

FIG. 8 another flowchart of the method for operating a measuring device according to a further embodiment,

FIG. 9 another flowchart of the method for operating a measuring device according to a further embodiment,

FIG. 10 a flowchart of a method for training an artificial intelligence of a measuring device according to one embodiment, and

FIG. 11 a schematic representation of a computer program product.

### DETAILED DESCRIPTION

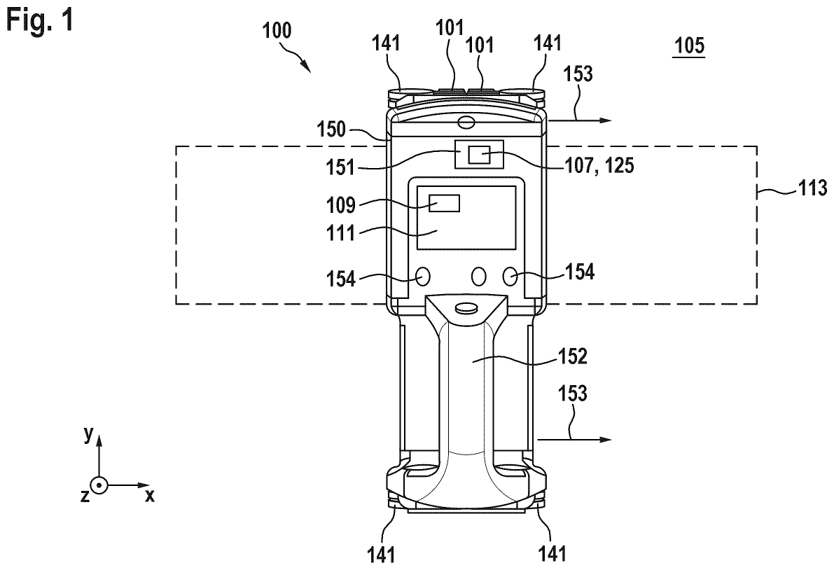

FIG. 1 shows a schematic representation of a measuring device 100 according to one embodiment.

The present disclosure relates to a measuring device, in particular a wall diagnostic device for examining walls 105 to be worked on. Wall diagnostic devices are known from the prior art that are used to detect objects located in walls. Such devices allow a user to examine walls to be processed to search for objects disposed in the walls in order to be able to perform planned work, for example drilling in walls, based on this such that damage to the objects disposed in the walls can be avoided.

In the embodiment shown, the measuring device 100 comprises a housing 150 having a handle 152 for grasping of the measuring device 100 by a user, a display unit 111 for displaying diagnostic results 109 of the wall diagnostics, and controls 154 for switching the measuring device 100 to various operating modes.

According to the disclosure, the measuring device 100 comprises at least one radar sensor unit 101. By way of the radar sensor unit 101, radar signals may be transmitted towards the wall 105 to be examined, and radar signals reflected by the wall 105 may be received.

For example, the radar sensor unit 101 may be configured as a narrow band radar detector device in the 2.4 gHz to 2.4835 gHz frequency range.

The measuring device 100 further comprises a diagnostic module 107 executable on a computing unit 151 of the measuring device 100 to perform the wall diagnostics. The diagnostic module 107 is configured to perform corresponding diagnostics on the wall to be examined based on the radar data 103 of the radar sensor unit 101. The radar data 103 of the radar sensor unit 101 thereby depicts the wall 105 to be examined and, if applicable, objects 113 located within the wall 105.

The wall diagnostics carried out by the diagnostic module 107 comprise at least performing object recognition. The object recognition comprises an object detection and an object classification of the object 113 located in the wall 105. The object detection comprises at least the determination of an object position 115. The object position describes the positioning of the object located in the wall 105 with respect to a reference system defined by the measuring device 100. The object classification of the detected object 113 comprises at least determining an object type 117 of the detected object 113.

The diagnostic results of the wall diagnostics determined in this way, i.e. at least the determined object position 115 and/or the determined object type 117 of the object 113 disposed in the wall 105, are subsequently presented in a display unit 111 of the measuring device 100 to a user of the measuring device 100. For example, the display unit 111 may be configured as a corresponding display, and the diagnostic results 109 may be visually displayed. Additionally, the display of the diagnostic results 109 may be supported via audible and/or haptic signals. For example, the haptic signals may be realized via corresponding vibration signals.

The object 113 may be shown in the display, for example, by way of a corresponding icon. The object 113 can be shown in the corresponding object position 115 in the display. The object extension 121 may be visualized by a corresponding size of the displayed icon. The particular object type 117 of the object 113 may be visualized with a corresponding term or color highlighting of the icon, or by a specific shape of the icon representing the object 113.

Alternatively, the wall diagnostics may additionally comprise determining a wall type 123 in the form of a wall type classification of the wall 105 to be examined. The wall type 123 describes the respective type of the wall 105 to be examined. For example, the wall type may be associated with corresponding wall type classes, which may comprise: Concrete wall, plasterboard/drywall wall, brick wall and/or wall bricks, underfloor heating, wall heating or similar wall types found in buildings.

According to one embodiment, the diagnostic module 107 is further configured to determine an object depth 119 of the object 113 within the wall 105 based on the radar data 103. The object depth 119 is defined by a distance of the object formed in the wall 105 to a surface of the wall 105. The distance may be defined on the object side, for example with respect to an object surface or with respect to an object center point. The distance to the surface of the wall 105 describes a shortest distance defined by a direction perpendicular to the surface of the wall 105.

According to one embodiment, the diagnostic module 107 is further configured to determine an object extension 121 of the object 113 in at least one predefined direction based on the radar data 103. The object extension 121 of the object 113 describes a spatial extension of the object 113 in at least one spatial direction, preferably in two spatial directions, particularly preferably in three spatial directions. The object 113 may be described here as a one-dimensional, two-dimensional, or three-dimensional object 113.

In conventional use, the measuring device 100 is placed on the surface of the wall 105 to be examined. Radar signals are transmitted towards the wall 105, and radar signals reflected from the wall 105 or the objects 113 located behind it are received, via the radar sensor unit 101. This radar data 103 of the radar sensor unit 101 is used by the diagnostic module 107 to perform the wall diagnostics described above and to determine corresponding diagnostic results 109.

For example, the diagnostic results 109 may comprise the object position 115 and/or object type 117 of the object 113 located in the wall 105. Alternatively or additionally, the diagnostic results 109 may comprise the wall type 123 of the wall 105 and/or the object depth 119 and/or the object extension 121 of the object 113.

The diagnostic results 109 configured in this manner may subsequently be displayed to a user of the measuring device 100 in a display unit 111 of the measuring device 100. The display unit 111 can be configured as a corresponding display, for example. The diagnostic results 109 may be displayed in graphical or textual form in the display unit 111.

According to one embodiment, the measuring device 100 further comprises a motion detection unit 141. The motion detection unit 141 may be used to detect movement of the measuring device 100 relative to the wall 105. The motion detection unit 141 may comprise, for example, at least one roller element for this purpose. When the roller element is placed on the wall surface of the wall 105, movement of the measuring device 100 relative to the wall 105 can be detected when the measuring device 100 moves along a direction of movement 153 by rolling the roller element. Alternatively, the motion detection unit 141 may have a different configuration by which a relative movement of the measuring device 100 relative to the wall 105 can be detected.

By moving the measuring device 100 relative to the wall 105, radar data 103 of the radar sensor unit 101 may be captured for a plurality of different positions of the measuring device 100 relative to the wall 105. This allows a larger spatial area of the wall 105 to be examined than the effective range of the radar sensor unit 101. This allows for objects 113 to be captured that have a greater spatial extent than the effective range of the radar sensor unit 101.

While the measuring device 100 moves along the direction of movement 153, radar data 103 of the radar sensor unit 101 may be captured continuously. The wall diagnostics may be evaluated by the diagnostic module 107 based on this radar data 103 while the measuring device 100 is moving along the direction of movement 153. This allows for accelerated wall diagnostics, taking into account the positioning of the measuring device 100 relative to the wall 105.

According to its embodiment, the diagnostic module 107 is configured as a correspondingly trained artificial intelligence 125. The artificial intelligence 125 is trained to perform the above-mentioned wall diagnostics based on the radar data 103 of the radar sensor unit 101 and to determine at least the object position 115 and the object type 117 of an object 113 located in the wall 105. The object classification or determination of the object type 117, respectively, comprises assigning the detected object 113 to predefined object classes.

The object classes may comprise: Metallic/non-metallic object, low voltage cable, single phase AC signal cable, multiphase AC signal cable, wood beam, metal beam, plastic pipe, water filled plastic pipe, for example fresh water pipe, non-water filled plastic pipe, for example waste water pipe, or other elements commonly installed in building walls.

Furthermore, the artificial intelligence 125 may be trained to determine the wall type 123 of the wall 105 to be examined at least based on the radar data 103 of the radar sensor unit 101. Possible wall types 123 may comprise: Concrete wall, plasterboard/drywall wall, brick wall and/or individual bricks of the brick wall, underfloor heating, wall heating or other similar wall types commonly installed in buildings.

According to one embodiment, in addition to the radar sensor unit 101, the measuring device 100 may comprise further additional sensors by way of which additional physical variables are detectable. For example, the measuring device 100 may comprise an induction sensor and/or an eddy current sensor and/or a capacitance sensor and/or an AC current sensor and/or an NMR sensor and/or an ultrasonic sensor or other sensors commonly used in wall diagnostic devices.

The diagnostic module 107, in particular the corresponding trained artificial intelligence 125, can be configured to perform wall diagnostics based on the radar data 103 of the radar sensor unit 101 and taking into account the additional sensor information of the further sensors described above. The additional information of the additional sensors mentioned above can particularly be used for object recognition of the objects 113 located in the walls 105. The additional sensor information may possibly provide improved detection of the objects 113 and may possibly provide improved classification of the objects 113.

For example, the material of the objects 113, for example as a metallic or non-metallic material, can be particularly improved and classified by using the additional sensor information.

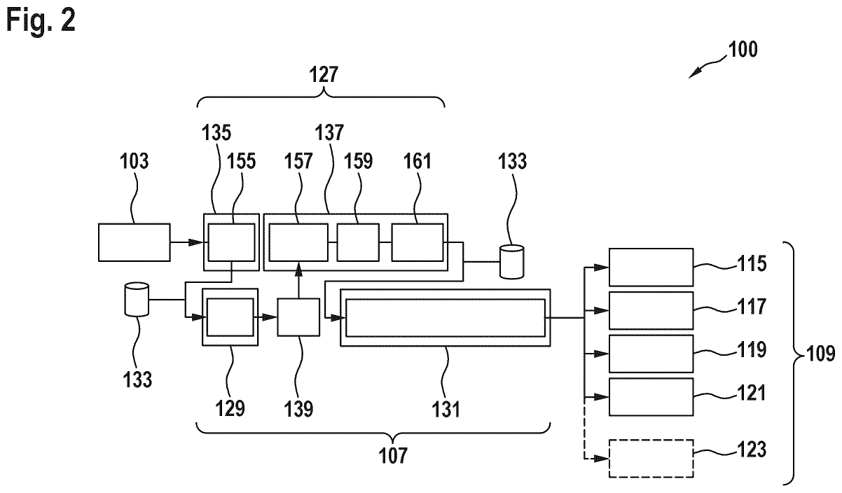

FIG. 2 shows another schematic representation of the measuring device 100 according to a further embodiment.

In the embodiment shown, the measuring device 100 comprises a pre-processing module 127 in addition to the diagnostic module 107. For wall diagnostics, the measuring device 100 first receives the radar data 103 of the radar sensor unit 101. Pre-processing of the receiving radar data 103 is performed via the pre-processing module 127. For example, via pre-processing by the pre-processing module 127, the radar data may be brought into a corresponding data structure required for wall diagnostics by the diagnostic module 107.

As described above, during wall diagnostics, the diagnostic module 107 generates the diagnostic results 109 described above. For example, the diagnostic results 109 may comprise the object position 115 and/or object type 117 and/or object depth 119 and/or object extension 121 of an object 113 formed in the wall 105 to be examined and/or the wall type 123 of the wall 105 to be examined. The correspondingly generated diagnostic results 109 may subsequently be displayed in the display unit 111 of the measuring device 100.

According to one embodiment, in addition to the radar data 103 of the radar sensor unit 101, the additional sensor information of the additional sensors described above may be considered during the wall diagnostics of diagnostic module 107. A corresponding pre-processing of the additional sensor information may be performed accordingly by the pre-processing module 127.

In the embodiment shown, the diagnostic module 107 comprises a wall type classification module 129 and an object recognition module 131. The pre-processing module 127 comprises a first pre-processing module 135 and a second pre-processing module 137. The first pre-processing module 135 comprises an S matrix reduction 155. The second pre-processing module 137 comprises a background correction 157, an inverse Fast Fourier transformation 159, and a focusing and migration 161. During the pre-processing of the radar data 103 by the pre-processing module 127, the radar data 103 is first pre-processed by the first pre-processing module 135 and the S-matrix reduction 155 contained therein.

When doing so, the first pre-processing module 135 generates input data 133 based on the radar data 103. The input data 133 serves as input data for the wall type classification module 129. The wall type classification module 129 performs a wall type classification of the wall 105 to be examined based on the input data 133 and generates wall type information 139. The wall type information 139 contains the wall type 123 of the wall 105 to be examined, as determined in the wall type classification.

Subsequently, the second pre-processing module 137 performs pre-processing based on the radar data 103 and the wall type information 139. A background correction 157 of the radar data 103 is performed during this, taking into account the wall type 123 determined in the wall type information 139. Depending on the wall type 123 of the wall 105 to be examined, different effects can occur on the radar data 103.

These effects, which are primarily based on the respective wall type 123 and can affect object recognition, can be corrected by the background correction 157. After the background correction has been performed, further pre-processing can be carried out by performing the inverse Fast Fourier transformation 159 or focusing and migration 161, respectively, and input data 133 can be created for the object recognition module 131 once again. Based on the input data 133 provided by the second pre-processing module 137, the object recognition module 133 performs object recognition of the object 113 located in the wall 105 to be examined and determines at least the object position 115 and the object type 117 of the respective object 113. Additionally, the object depth 119 and the object extension 121 may be determined by the object recognition module 131.

According to one embodiment, the diagnostic module is further configured to determine an object depth of the object within the wall based on the radar data, wherein the object depth is defined by a distance of the object formed in the wall to a surface of the wall.

The pre-processing is optional. Depending on the algorithm used for the diagnostic module 107, completely unprocessed radar echoes of different frequencies may be used as radar data 103 and as input data for the diagnostic module 107. Alternatively, radar data 103 processed via multiple steps may be used. The pre-processing steps comprise, for example, the transformation of the signals from the frequency domain to the time or distance domain, background deduction, noise removal, and normalization of the signals. For radar data 103 which is available in the form of complex numbers, only the absolute value can be processed. Alternatively or additionally, the phase information may be considered.

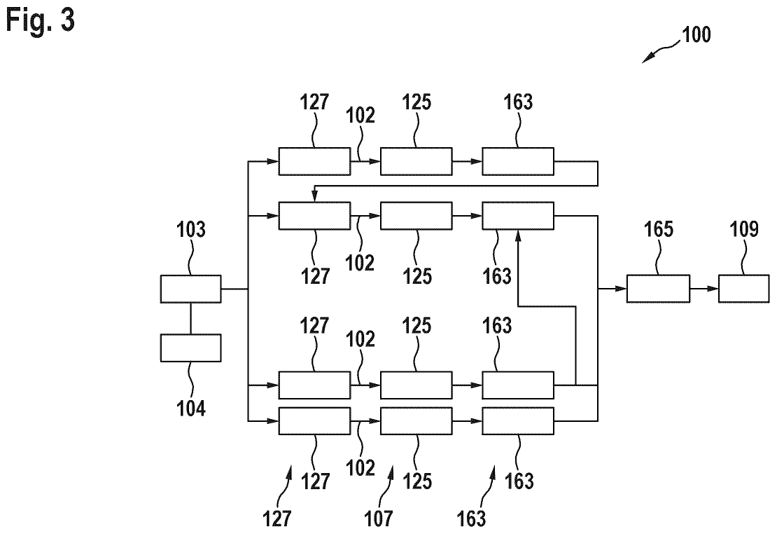

FIG. 3 shows a further schematic representation of the measuring device 100 according to a further embodiment.

In the embodiment shown, the diagnostic module 107 comprises a plurality of parallel processing paths 102. Each processing path 102 includes a pre-processing module 127, the diagnostic module 107, comprising the wall type classification module 129 and/or the object recognition module 131, for example, according to the embodiment in FIG. 2, and a post-processing module 163.

In FIG. 3, primarily the radar data 103 is shown as input data for the wall diagnostics. In addition to the radar data shown, however, the additional information from the additional sensors may also serve as input data for the wall diagnostics. The different information from the different types of sensors in the different parallel processing paths 102 can be processed and the corresponding wall diagnostics performed separately on the different sensor information. Upon completion of the wall diagnostics, a summary module may be used to assemble a summary of the individual partial analysis results for the diagnostic results 109 of the wall diagnostics.

Alternatively or additionally, different sub-aspects of wall diagnostics may be performed by the different processing paths 102 based on the same sensor information.

For example, the individual processing paths 102 may process different radar data 103 captured during movement of the measuring device 100 relative to the wall 105 for different positions of the measuring device 100 relative to the wall 105. The radar data 103, thus representing different regions of the wall 105 and captured sequentially in time as the measuring device 100 moves relative to the wall 105, may then be processed in the different processing paths 102 by the modules shown.

The various processing paths perform stand-alone wall diagnostics including at least determining the object position 115 and/or the object type 117 of the object 113 located in the wall 105.

By way of the summary module 165, the partial results of the stand-alone wall diagnostics of the different regions of the wall 105 provided in the individual processing paths 102 can be summarized to a contiguous diagnostic result 109. The contiguous diagnostic result describes the wall diagnostics of a contiguous spatial area that was scanned during movement of the measuring device 100 relative to the wall 105 and depicted by the corresponding captured radar data 103. The parallel processing of the radar data 103 or additional sensor information 104 of the additional sensor elements in the different processing paths 102 thus enables accelerated wall diagnostics.

Alternatively, various wall diagnostic functions may also be performed in the different processing paths 102. For example, in one processing path 102, the wall type classification and the determination of the wall type 123 of the wall 105 to be examined can be performed. In another processing path 102, object recognition of the object 113 located in the wall can be performed. The object detection can be performed with the determination of the object position 115 and the object classification can be performed with the determination of the object type 113 in one processing path 102.

Alternatively, the object detection and object classification may then also be performed in two separate processing paths 102. In further processing paths 102, the object depth determination, i.e., the determination of the object depth 119 and/or the determination of the object extension 121 may each be carried out. In the summary module 165, the various partial results of the wall diagnostics may be summarized into corresponding diagnostic results 109.

The diagnostic module 107 can be divided into different artificial intelligence structures 125, as already shown in the embodiment in FIG. 2. For example, the diagnostic module 107 may comprise a wall type classification module 129 and an object recognition module 131. The object recognition module may in turn be divided into an object detection module and an object classification module. The diagnostic module 107 may further comprise an object depth determination module and object extension module, respectively configured to determine the object depth 119 and the object extension 121.

The respective modules may each be configured as stand-alone artificial intelligence structures 125, for example, neural networks. Alternatively, the various modules may form portions of an overall artificial neural network that are connected to an overall neural network according to structures known from prior art.

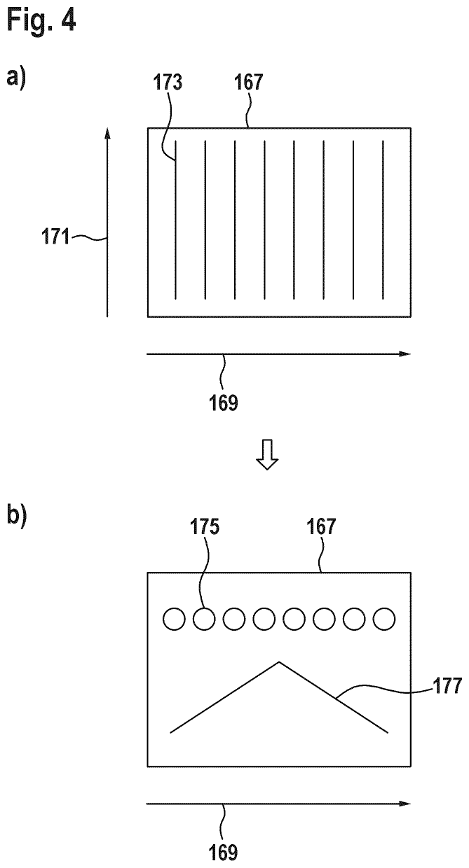

FIG. 4 shows a schematic illustration of a measurement by the measuring device 100 according to one embodiment.

For pre-processing, the radar data 103 or the additional sensor information 104 of the remaining sensors may be normalized, in particular to numerically stabilize the subsequent steps performed by the diagnostic module 107 during the wall diagnostics. For example, an amplitude and/or offset compensation may be performed for this purpose. Moreover, to reduce interference, filtering of the radar data 103 may be carried out, and to reduce the data rate, the corresponding sensor data may be sampled. Additionally, the radar data 103 or the additional sensor information 104 may be transformed into the respectively required frequency range or time range. Methods known from the prior art can be used for this purpose.

Furthermore, the captured radar data 103 or additional sensor information 104 may be divided into temporal or spatial windows 167. Temporal windows 167 may be generated by recording the radar data 103 or the additional sensor information or the pre-processed radar data 103 over a fixed time interval. Spatial windows 167, on the other hand, may be generated from a mapping of the radar data 103 or additional sensor information 104 to positions of the measuring device 100 relative to the wall 105 along the direction of movement 153.

Graph a) of FIG. 4 shows such a data matrix resulting from the steps described above. The data matrix of the window 167 shown in graph a) shows a plurality of sensor data 173, which may comprise, for example, radar data 103 or additional sensor information 104 of the further sensors plotted along a frequency channel axis 171 or along a space/time axis 169, respectively.

A width of the temporal windows 167 may be selected such that different sampling rates of the sensors may be balanced and a new window 167 may be provided frequently enough so that a display of the diagnostic results 109 of the wall diagnostics in the display unit 111 may be shown without too great of a time delay while the measurement is being performed or shortly after the measurement by the measuring device 100 ends.

A rate of 2 to 20 windows per second of the data recording of the sensor data 173 may be advantageous for this purpose. For spatial windows, the spatial sampling rates can be selected to achieve the desired local accuracy. Advantageously, 1 mm to 1 cm sampling rates can be used. This means that corresponding sensor data 173 is captured every 1 mm to 1 cm of movement of the measuring device 100 along the direction of movement 153.

A width of the spatial windows 167 may be selected such that contiguous information relating to an object 113 is contained in a window. Advantageously, a width of the respective spatial windows 167 can be 1 cm to 20 cm. This results in 4 to 100 measured values per window 167. This allows for further efficient algorithmic processing of the correspondingly recorded radar data 103 or additional sensor information by the diagnostic module 107.

A further temporal window 167 or spatial window 167 can be provided as soon as one or more sampling points are available.

The diagnostic module 107 may be oriented such that a matrix corresponding to the window size of the respective spatial or temporal window 167 may be included as input data, for example of each processing path 102 of the embodiment in FIG. 3 as well. According to the embodiment in FIG. 2, the corresponding input data can comprise the respective pre-processed sensor data, i.e. radar data 103 and additional sensor information 104 of the additional sensors.

As stated above, the wall diagnostics may be performed by the diagnostic module 107 based on a correspondingly trained artificial intelligence. Alternatively, different processing paths may also be calculated by way of rule-based algorithms. In addition, within a processing path 102, a combination of artificial intelligence and rule-based algorithm is possible in the form of a parallel operation or concatenation.

The diagnostic results 109 of the wall diagnostics may be expressed as numeric values, vectors, or matrices. Furthermore, for the object detection, the probability of detection, or for the wall type classification and/or the object classification, respectively, a probability of the specified object classes and/or wall type classifications can be indicated. The same may apply to the position and/or depth determination, for which corresponding probability values can also be indicated.

In addition to the radar data 103, if the additional sensor information of the further sensor types is processed in a processing path 102, these may either be merged within the artificial intelligence 125 or combined by way of rule-based combinations.

During the post-processing of each processing path 102, of the embodiment in FIG. 3, multiple algorithm results based on multiple windows 167 may be summarized by the summary module 165. This summary can in particular be realized by way of majority formation, sum formation or also by multiplication of successive probability values.

Furthermore, by clustering multiple results, for example, it is possible to detect which objects, of multiple detected objects located close to one another, are the same object so that they are not incorrectly detected multiple times.

Likewise, it is possible to multiplicatively apply a weighting function 177 when summarizing the results from multiple windows 167. Advantageously, the diagnostic partial results 175 corresponding to corresponding data points in the space may be weighted with respect to positioning of the diagnostic partial results 175 relative to a center point of the respective window 167. This is illustrated by way of example in graph b), in which the individual diagnostic partial results 175 are weighted according to the weighting function 177 shown with respect to the center point of the window 167 shown.

According to one embodiment, the results of one processing path 102 after post-processing 163 may influence the extension of another processing path 102. Weighting parameters may be adjusted that may depend on the particular result from the processing path 102 for each window.

For example, the result of an object classification in which the object type 117 of an object located in the wall 105 is defined, can be used to increase the weight of a wall type classification, in which the wall type 123 of the respective wall 105 is determined, during the post-processing at locations without objects 113, because the respective radar data 103 at these locations is less influenced by reflections of the objects 113.

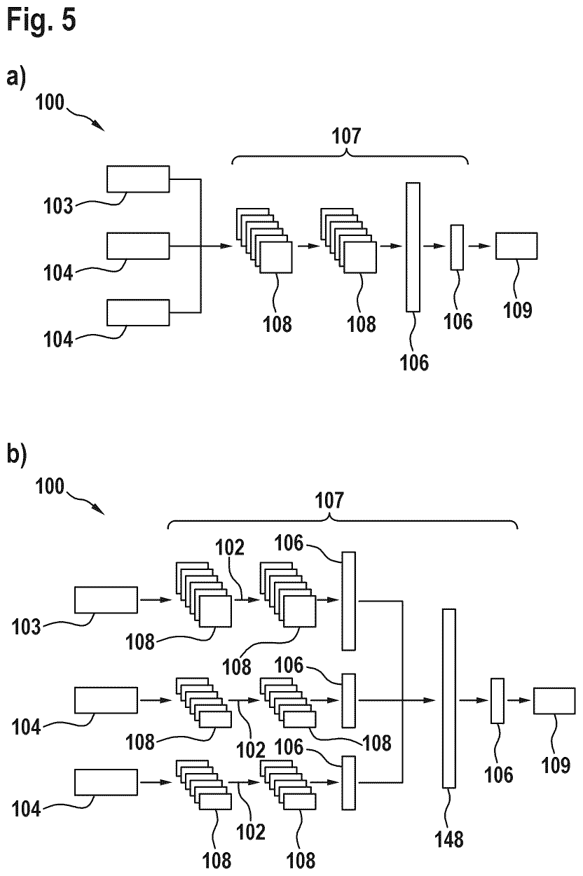

FIG. 5 shows a further schematic representation of the measuring device 100 according to a further embodiment.

Graphs a) and b) of FIG. 5 show two different alternatives of joint data processing of radar data 103 and additional sensor information 104 by the diagnostic module 107.

Graph b) illustrates a joint processing of the radar data 103 and the additional sensor information 104 of the additional sensors by the diagnostic module 107. For this purpose, the radar data 103 and the additional sensor information 104 are collectively used as input data of the diagnostic module 107 configured as an artificial intelligence, in particular as an artificial neural network. The diagnostic module 107 here comprises multiple convolutions 108 and multiple dense layers 106. The radar data 103 and the additional sensor information 104 are processed jointly as input data via the convolutions 108 and dense layers 106. The aforementioned diagnostic results 109 are created as output data of the diagnostic module 107 based on this.

On the other hand, in graph b) the radar data 103 and the additional sensor information 104 are used as stand-alone input data of the diagnostic module 107. The diagnostic module 107 becomes multiple processing paths 102. The processing paths 102 each comprise multiple convolutions 108 and at least one dense layer 106. In the various processing paths 102, wall diagnostics are performed separately by the diagnostic module 107 based on the radar data 103 and the additional sensor information 104, respectively.

In an additional concatenation layer 148, the partial results of the partial diagnostics of the different processing paths 102 are combined and fed to a final dense layer 106. The output data of the diagnostic module 107 corresponds to the diagnostic results 109 described above.

The correspondingly configured diagnostic module 107 is configured to perform wall diagnostics as described above, including the features described above, based on the radar data 103 and the additional sensor information 104.

In the embodiment shown, the diagnostic module 107 is configured as an artificial neural network, in particular as a convolutional network. Corresponding network architectures with convolutions 108, dense layers 106, and concatenation layers 148 are known from the prior art.

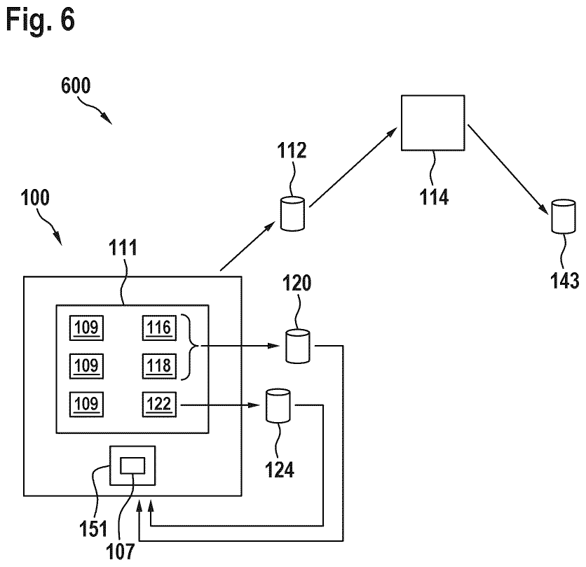

FIG. 6 shows a schematic representation of a system 600 for operating a measuring device 100 according to one embodiment.

In the embodiment shown, the system 600 for operating a measuring device 100 comprises an external server unit 114 in addition to the measuring device 100.

According to the disclosure, the measuring device 100 is configured to perform the wall diagnostics of the wall 105 to be examined including the objects 113 disposed therein using the diagnostic module 107 based on the radar data 103 of the radar sensor unit 101 and, if necessary, taking into account the additional sensor information 104.

According to the disclosure, the wall diagnostics comprises at least determining the wall type 123 of the wall 105 and/or determining the object position 115 and/or the object type 117 of the at least one object 113 disposed in the wall. The correspondingly provided diagnostic results 109 thus include at least the determined wall type 123 and/or the determined object position 115 and/or the object type 117.

Alternatively, the wall diagnostics may also include determining the object depth 119 and/or the object extent 121.

According to the disclosure, feedback information 112 is determined by the measuring device 100. Feedback information 112 describes a match of the diagnostic results 109 with a current state of the wall 105. The current state of the wall 105 relates to the actual present wall type 123 and/or the actual present object position 115 or the actual object type 117 of the at least one object 113 disposed in the wall.

In the embodiment shown, the feedback information 112 of the measuring device 100 is provided to the external server unit 114. The external server unit 114 is configured to use the feedback information 112 to improve the software of the diagnostic module 107, for example, by re-training the diagnostic module 107. In particular, the external server unit 114 is configured to generate a training dataset 143 for re-training the diagnostic module 107, taking into account the feedback information 112.

According to one embodiment, radar data 103 may be provided by the measuring device 100 of the external server unit 114 along with the feedback information 112, on the basis of which the wall diagnostics were performed by the diagnostic module 107 to which the feedback information 112 was provided by the user of the measuring device.

In the embodiment shown, the measuring device 100 further provides a first selection function 116 and a second selection function 118.

Via the first selection function 116, the user of the measuring device 100 may select a wall type 123 and/or an object position 115 and/or an object type 117 and/or an object depth 119 and/or an object extent 121 from a plurality of possible wall types 123 provided by the measuring device 100 and/or a plurality of possible object positions 115 and/or a plurality of possible object types 117 and/or a plurality of possible object depths 119 and/or a plurality of possible object extents 121, provided as diagnostic results 109 by the diagnostic module 107 during wall diagnostics. The user may thus select the diagnostic results 109 which, in their opinion, best reflect the actual state of the wall 105 by actuating the first selection function 116.

By way of the second selection function 118, the user may deactivate the automatic wall type determination. Further, the user may manually input a present wall type 123.

In the embodiment shown, the measuring device 100 further provides a feedback function 122. The feedback function 122 allows the user to provide direct feedback on whether the wall diagnostics match the actual state of the wall 105.

For this purpose, the selection commands 120 of the first and second selection functions 116, 118 input by the user are received from the diagnostic module 107. The selection commands 120 here describe the selections made by the user from the diagnostic results 109 provided by the diagnostic module 107 by actuating the first selection function 116 and/or the second selection function 118 or by terminating the automatic performance of the wall type determination.

Further, corresponding feedback commands 124 of the feedback function 122 may be received by the diagnostic module 107. The feedback commands 124 include the feedback information 112 provided by the user by actuating the feedback function 122.

In addition to the feedback commands 124, the measuring device 100 is configured to determine the feedback information 112 based on the selection commands 120 of the first and second selection functions 116, 118. For example, if a plurality of possible wall types 123 are provided, selecting one of the wall types 123 will provide positive feedback regarding the respective wall type 123 selected, while negatively evaluating the non-selected wall types 123, respectively. Accordingly, when the second selection function 118 is activated, in which the automatic wall type determination is deactivated, negative feedback is registered regarding the wall type determination. The same applies to the selections for the further diagnostic results 109.

According to one embodiment, the diagnostic module 107 is further configured to determine deviations between the repeated wall diagnostics or diagnostic results 109 during the wall diagnostics respectively performed at the same positions of the measuring device 100 relative to the wall 105.

Further, the measuring device 100 is configured to display the corresponding deviations in the display unit 111. By actuating the feedback function 122, the user can confirm or refute the deviations with corresponding feedback commands 124.

For example, the selection commands 120 and/or the feedback commands 124 may be input by controls 154. Alternatively, the display unit 111 may be configured as a touch screen, for example, via which the selection commands 120 and/or feedback commands 124 can be input by the user.

The deviations between the diagnostic results 109 of the different wall diagnoses for the same position of the measuring device 100 relative to the wall 105 may be determined using the diagnostic module 107, for example, by comparative processes between the diagnostic results 109 determined in the different wall diagnostics at different times. For this purpose, the diagnostic module 107 may comprise a correspondingly configured comparison module.

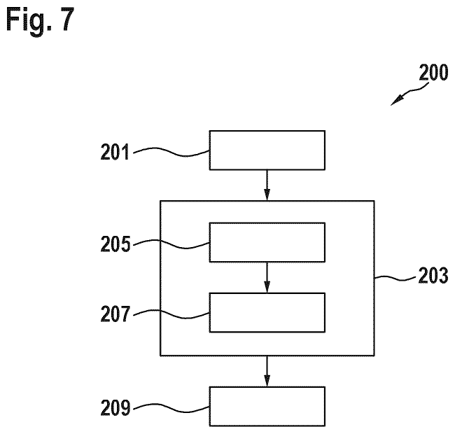

FIG. 7 shows a flowchart of a method 200 for operating a measuring device 100 according to one embodiment.

To operate the measuring device 100, the radar data 103 of the radar sensor unit 101 of the measuring device 100 depicting the wall 105 to be diagnosed is first received in a method step 201.

In another method step 203, the wall diagnostics are performed by the diagnostic module 107 based on the radar data 103, and diagnostic results 109 are provided.

For this purpose, a wall type classification is carried out by the diagnostic module 107 and the wall type 123 of the wall 105 is determined in a method step 205.

In a further method step 207, an object recognition of the at least one object 113 disposed in the wall 105 is performed by the diagnostic module 107. The object recognition includes an object detection and the determination of the object position 115 and the object classification with the determination of the object type 117. The diagnostic results 109 provided by the diagnostic module 107 include at least the object position 115 and/or the object type 117 and the wall type 123, respectively.

Further, feedback information 112 is determined in a method step 209. Feedback information 112 describes whether the diagnostic results 109 match the current state of the wall 105.

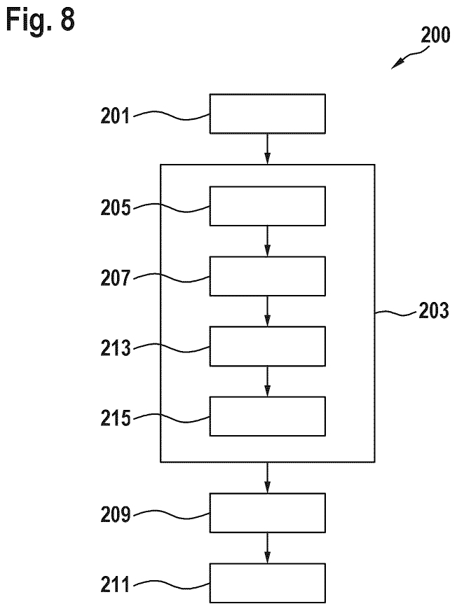

FIG. 8 shows another flowchart of the method 200 for operating a measuring device 100 according to a further embodiment.

The embodiment shown in FIG. 8 is based on the embodiment in FIG. 7 and comprises all the method steps described there.

In the embodiment shown, the wall diagnostics further comprises performing the object depth determination and determining the object depth 119 of the object 113 in a method step 213.

Further, in a method step 215, the object extension determination is performed and the object extension 121 of the object 113 is determined.

Further, in a method step 211, the feedback information 112 is provided to an external server unit 114 to take the feedback information 112 into consideration in an update to the diagnostic module 107.

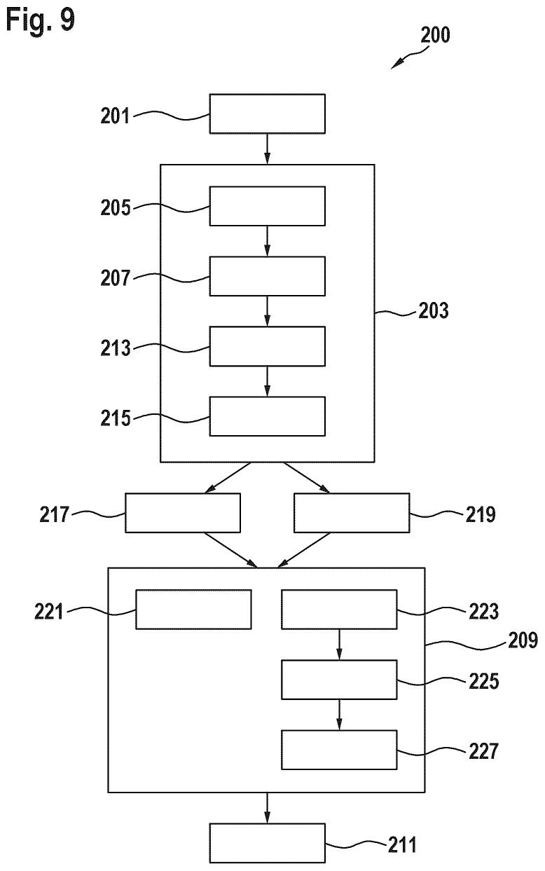

FIG. 9 shows another flowchart of the method 200 for operating a measuring device 100 according to a further embodiment.

The embodiment shown in FIG. 9 is based on the embodiment in FIG. 8 and comprises all the method steps described there.

In the embodiment shown, the first selection function 116 and/or the second selection function 118 is provided in a method step 217.

By performing the first selection function 116, a suitable wall type 123 and/or a suitable object position 115 and/or a suitable object type 117 and/or a suitable object depth 119 and/or a suitable object extent 121 can be selected from the plurality of possible wall types 123 and/or possible object positions 115 and/or possible object types 117 and/or possible object depths 119 and/or possible object extents 121.

By performing the second selection function 118, the automatic wall type determination may be disabled and the wall type 123 may be manually selected.

Further, the feedback function 122 is provided in a further method step 219. By actuating the feedback function 122, the user can provide the feedback information 112. The feedback information 112 may be used to provide the feedback regarding whether the provided diagnostic results 109 match the actual state of the wall 105.

In the embodiment shown, determining 209 the feedback information 112 further includes receiving selection commands 120 from the first and/or second selection functions 116, 118, and/or feedback commands 124 from the feedback function 122 and determining the feedback information 112 based on the selection commands 120 and/or the feedback commands 124 in a method step 221.

Further, in a method step 223, the diagnostic module 107 determines whether there are deviations from the diagnostic results 109 determined in the wall diagnostics in repeated wall diagnostics of a same position of the measuring device 100 relative to the wall 105.

In a further method step 225, the deviations are displayed in the display unit 111.

In a further method step 227, feedback commands 124 are received regarding the deviations, wherein the displayed deviations are confirmed or rejected in the feedback commands 124.

According to one embodiment, the corresponding radar data 103 on which the wall diagnostics were previously performed is provided in the external server unit 114, in addition to the feedback information 112. The feedback information 112 may be provided to the external server unit 114 by a plurality of measuring devices 100 that are in use by users.

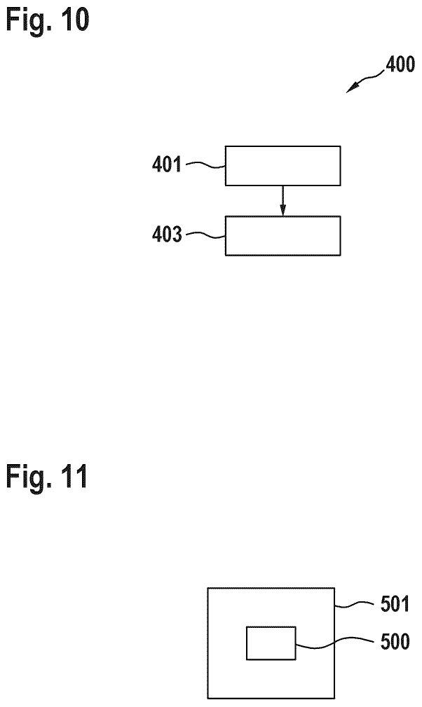

FIG. 10 shows a flowchart of a method 400 for generating a training dataset for training an artificial intelligence 125 of a measuring device 100 according to one embodiment.

To train the artificial intelligence, in a first method step 401, firstly the training dataset 143 generated according to method 200 is provided, wherein the training dataset 143 comprises the radar data 103 depicting the wall 105 to be diagnosed and the at least one object 113 configured in the wall 105 and the feedback information 112 provided according to method 200 for operating a measuring device 100 according to any of the preceding embodiments.

In a further method step 403, the artificial intelligence 125 is trained based on the training dataset 143 and taking into account feedback information 112 for performing an object recognition of an object 113 formed in a wall 105. The training is carried out in such a way that the feedback information 112 is considered by the correspondingly trained artificial intelligence when performing the wall diagnostics.

FIG. 11 shows a schematic representation of a computer program product 500 comprising instructions that, when the program is executed by a data processing unit, cause the latter to perform the method 200 for operating a measuring device 100 and/or the method 400 for training an artificial intelligence 125.

In the embodiment shown, the computer program product 500 is stored on a storage medium 501. The storage medium 501 can in this case be any desired storage medium known from the prior art.

What is claimed is:

1. A computer-implemented method of operating a measuring device, comprising:
receiving radar data of a radar sensor unit of the measuring device, wherein the radar data depicts a wall on which diagnostics are to be performed; and
performing wall diagnostics by performing an analysis of the radar data and providing diagnostic results by a diagnostic module of the measuring device, wherein the performing wall diagnostics comprise:
performing a wall type classification and determining a wall type of the wall by way of the diagnostic module, wherein the diagnostic results comprise at least the wall type of the wall; and/or
performing an object recognition of an object disposed in the wall using the diagnostic module, wherein the object recognition comprises an object detection and an object classification and determining an object position in the wall and an object type of the object, and wherein the diagnostic results comprise at least the object position and/or the object type; and
determining feedback information, wherein the feedback information describes whether the diagnostic results match a current state of the wall.

2. The method according to claim 1, further comprising:
providing the feedback information to an external server unit to take the feedback information into account in an update to the diagnostic module.

3. The method of claim 2, wherein in addition to the feedback information, the corresponding radar data is provided to the external server unit.

4. The method of claim 1, wherein the performing wall diagnostics further comprises:
performing an object depth determination and determining an object depth of the object in the wall using the diagnostic module, wherein the object depth is defined as a distance of the object to a surface of the wall; and/or
performing an object extent determination and determining an object extent of the object along a predefined direction using the diagnostic module, wherein the diagnostic results further comprise at least the object depth and/or the object extent of the object.

5. The method of claim 1, wherein a plurality of possible object positions and/or a plurality of possible object types of the object are determined in the object recognition as stand-alone diagnostic results, and/or wherein a plurality of possible wall types of the wall are determined in the wall type classification as independent diagnostic results, and/or wherein a plurality of possible object depths are determined as stand-alone diagnostic results in the object depth determination and/or wherein a plurality of possible object extents of the object are determined in the object extent determination as stand-alone diagnostic results, wherein each of the plurality of diagnostic results is displayed in a display unit of the measuring device.

6. The method according to claim 5, further comprising:
providing a first selection function and/or a second selection function, wherein at least one of the displayed wall types and/or one of the displayed object positions and/or object types and/or object depths and/or object extents is selectable by a user of the measuring device by performing the first selection function, and/or wherein the automatic determination of the wall type can be deactivated during the wall diagnostics and/or the display of the automatically determined wall type in the display unit can be deactivated by the user of the measuring device by performing the second selection function, and a wall type is manually selectable by the user.

7. The method according to claim 6, further comprising:
providing a feedback function, wherein, when the user performs the feedback function, they can indicate whether the displayed wall type and/or the displayed object position and/or the displayed object type and/or the displayed object depth and/or the displayed object extent match the actual wall type and/or the actual object position and/or the actual object type and/or the actual object depth and/or the actual object extent.

8. The method of claim 6, wherein determining the feedback information comprises:
receiving selection commands from the first and/or second selection function and/or feedback commands from the feedback function and determining the feedback information based on the selection commands and/or feedback commands, wherein corresponding selections are made in the selection commands, according to the first and/or second selection functions, and wherein corresponding feedback information provided by the user is included in the feedback commands.

9. The method according to claim 1, wherein determining the feedback information comprises:
determining, using the diagnostic module, whether there are deviations from the diagnostic results determined in the wall diagnostics when repeated diagnostics are carried out for a same position of the measuring device relative to the wall;
displaying the deviations in the display unit; and
receiving feedback commands from the user regarding the deviations, wherein the displayed deviations are confirmed or refuted in the feedback commands.

10. The method according to claim 1, wherein the measuring device further comprises at least one of an induction sensor and/or an eddy current sensor and/or a capacitance sensor and/or an AC current sensor and/or an NMR sensor and/or an ultrasonic sensor for providing additional sensor data, and wherein the diagnostic module is configured to perform the wall diagnostics by taking into account the additional sensor data.

11. The method according to claim 1, wherein the diagnostic module comprises at least one correspondingly trained artificial intelligence configured to perform object detection and/or a wall classification and/or an object depth determination and/or an object extension determination based on the radar data and/or the additional sensor data.

12. The method according to claim 1, wherein object classes of the object type of the object comprise: metallic/non-metallic object, low voltage cable, magnetic/non-magnetic objects, cable with single phase AC signal, cable with multiphase AC signal, wood beam, metal beam, plastic pipe, water filled plastic pipe, non-water filled plastic pipe, and/or wherein the wall type classes of the wall type of the wall comprise: concrete wall, plasterboard/drywall wall, brick wall and/or bricks of the wall, underfloor heating, wall heating.

13. A method for training an artificial intelligence of a measuring device, comprising:
providing a training dataset for training the artificial intelligence, wherein the training dataset comprises a wall and radar data depicting an object formed in the wall, as well as the feedback information provided according to the method for operating a measuring device according to claim 1; and
training the artificial intelligence based on the training dataset and taking into account the feedback information for performing object recognition of an object formed in a wall, wherein the object recognition comprises at least one of object detection and object classification.

14. A computing unit configured to perform the method for operating a measuring device according to claim 1.

15. A computer program product comprising instructions that, when the program is executed by a data processing unit, cause the latter to perform the method for operating a measuring device according to claim 1.

16. The method according to claim 1, wherein the measuring device is a wall diagnostic device.

17. The method according to claim 12, wherein:
the water filled plastic pipe is a fresh water pipe, and
the non-water filled plastic pipe is a waste water pipe.

18. A computing unit configured to perform the method for training an artificial intelligence of a measuring device for wall diagnostics according to claim 13.

19. A computer program product comprising instructions that, when the program is executed by a data processing unit, cause the latter to perform the method for training an artificial intelligence of a measuring device to perform wall diagnostics according to claim 13.
